(19) United States
(12) Patent Application Publication
(10) Pub. No.: US 2025/0099203 A1
(43) Pub. Date: Mar. 27, 2025

(54) AIR TURBINE, DENTAL HANDPIECE, AND BOOST ADAPTER

(71) Applicant: Kazuyoshi SUZUKI, CHIBA (JP)

(72) Inventor: Kazuyoshi SUZUKI, CHIBA (JP)

(21) Appl. No.: 18/706,589

(22) PCT Filed: Oct. 21, 2022
(86) PCT No.: PCT/JP2022/039285

§ 371 Date: May 1, 2024

(30) Foreign Application Priority Data
Jan. 26, 2022 (JP) 2022-020854
Feb. 28, 2022 (JP) 2022-041903
Aug. 15, 2022 (JP) 2022-138655

(51) Int. Cl. A61C 1/05; A61C 3/02

(52) U.S. Cl. CPC A61C 1/052; A61C 3/02

(57) ABSTRACT

Provided are an air turbine that may increase a rotational cutting force of a cutting tool, a dental handpiece and the like that uses the air turbine. An air turbine 2 includes a rotary blade 20 (rotor), an upper shaft member 21 coaxially disposed on an upper side of the rotary blade 20, a lower shaft member 22 coaxially disposed on a lower side of the rotary blade 20, and a cutting tool 24 that has a tapered, substantially cylindrical shape and that extends coaxially downward from the lower shaft member 22. The rotary blade 20 is formed of ceramics or metal having a specific gravity of 3.0 or more, or a combination thereof (including a composite material).

### TECHNICAL FIELD

The present invention relates to an air turbine, a dental handpiece that uses the air turbine, and a boost adapter.

### BACKGROUND ART

An air-turbine dental handpiece is an instrument that rotates a rotary blade of an air turbine at a high speed with compressed air from a compressor, and that drills and/or removes a decayed tooth with a cutting tool that is generally coaxially attached to the rotary blade. For example, a dental handpiece includes a handle to be gripped by a practitioner, a housing provided at a tip end portion of the handle, and an air turbine including a rotary blade housed in an inner space of the housing and a cutting tool. Compressed air from a compressor is supplied to an air supply passage via an air supply pipe connected to a supply port of an air supply circuit including a pedal of a chair unit or the like, the air supply circuit being for controlling an air supply amount.

The air-turbine dental handpiece is desirably lightweight so as not to obstruct delicate manipulation by a dentist. Accordingly, for the rotary blade of the air turbine, light metal such as aluminum alloy having a specific gravity of 2.6 to 2.8 is used, for example.

### SUMMARY OF INVENTION

### Technical Problem

However, a dentist may feel dissatisfied with a rotational force of a cutting tool at the time of drilling a decayed tooth using a dental handpiece.

Accordingly, an object of the present invention is to provide an air turbine that may increase a rotational cutting force of a cutting tool, a dental handpiece that uses the air turbine, and the like.

### Solution to Problem

The present inventor conceived of adding a flywheel to a rotation shaft of an air turbine to increase a rotational force of a cutting tool, but reached a conclusion that a design of a dental handpiece has to be greatly changed due to having to change a structure of a housing to secure a space for attaching the flywheel, for example. The present inventor also conceived of increasing atmospheric pressure of compressed air to increase the rotational force of the cutting tool, but reached a conclusion that such a change requires a design of a structure of a chair unit to be greatly changed. Changing the design of the dental handpiece and/or the chair unit requires a great cost.

An air turbine of the present invention for solving the problem described above is an air turbine used in a dental handpiece, including:
a rotary blade, and a cutting tool which is coaxially coupled to the rotary blade, where
the rotary blade is formed of ceramics or metal with a specific gravity of 3.0 or more, or a combination of the ceramics and the metal.

A dental handpiece of the present invention includes:
a handle, a housing, and the air turbine according to claim 1, where
the handle includes an air supply passage for supplying compressed air to an inner space of the housing, and an air discharge passage for discharging the compressed air from the inner space of the housing to below the housing, and
the air turbine includes the rotary blade housed in the inner space of the housing, and the cutting tool which is coaxially coupled to the rotary blade, a tip end portion of the cutting tool protruding downward from the housing through an opening in the housing.

The rotary blade constituting the air turbine according to the present invention itself functions as a flywheel, and thus, there is no need to provide an additional flywheel. A rotational speed at an initial stage of rotation of the rotary blade is somewhat slow, but rotational torque is then increased and a rotational force of the cutting tool is thereby increased. The rotary blade of the air turbine is housed in the inner space of the housing (a housing space for the rotary blade) without having to change shape and/or size of the inner space.

With the air turbine and the dental handpiece configured in the manner described above, the rotary blade constituting the air turbine has a higher specific gravity than conventionally used rotary blades formed of various aluminum alloys (specific gravities of 2.6 to 2.8) such as aluminum (specific gravity of 2.7) and duralumin (specific gravity of 2.8). The air turbine according to the present invention may be formed by removing the rotary blade of an existing air turbine and replacing the rotary blade with the rotary blade of the present invention having a specific gravity of 3.0 or more. An air turbine that uses the rotary blade according to the present invention may be newly designed.

The dental handpiece having the configuration described above preferably includes:
a boost adapter including a three-path air passage formed from a first air passage and a second air passage which respectively communicate with a first air supply circuit and a second air supply circuit which are separate air circuits of a chair unit, and a combined air passage which combines the first air passage and the second air passage to communicate with the air supply passage.

In the case where the chair unit includes separate first air supply circuit and second air supply circuit for supplying compressed air, the compressed air supplied separately from the two air supply circuits is combined or merged and is supplied to the air supply passage. Accordingly, a rotational force of the air turbine is increased, and thus, a rotational cutting force of the cutting tool is increased.

### BRIEF DESCRIPTION OF DRAWINGS

FIG. 1 is an explanatory configuration diagram of a dental handpiece as an embodiment of the present invention.

FIG. 2 is an explanatory configuration diagram of an air turbine as an embodiment of the present invention.

FIG. 3 is an explanatory configuration diagram of a boost adapter.

### DESCRIPTION OF EMBODIMENT

### (Configuration)

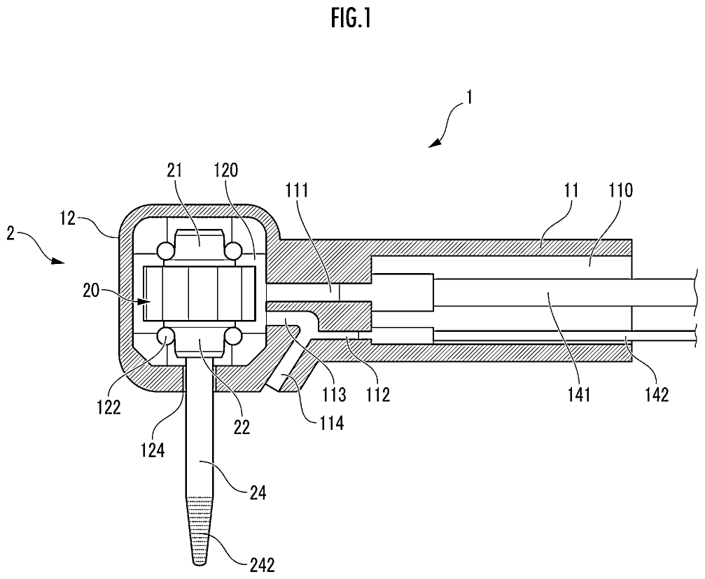

A dental handpiece 1 as a first embodiment of the present invention shown in FIG. 1 includes a handle 11 that is substantially cylindrical (or substantially cylindrical while being bent halfway at about 5° to 20°), a housing 12 that is substantially cylindrical, and an air turbine 2, where an axis line of the housing 12 is continuous to and substantially orthogonal to an axis line of a tip end portion of the handle 11.

An air supply pipe 141 and a water supply pipe 142 are disposed inside an inner space 110 of the handle 11 in a manner extending substantially parallel to an axis line direction or a longitudinal direction. The air supply pipe 141 is connected to a compressed air supply source via an air supply circuit of a chair unit. The water supply pipe 142 is connected to a water supply source. An air supply passage 111 for supplying compressed air supplied from the air supply pipe 141 into an inner space 120 of the housing 12, an air discharge passage 114 for discharging the compressed air from the inner space 120 of the housing 12 to an outside space, and a water supply passage 112 for supplying water supplied from the water supply pipe 142 into the air discharge passage 114 are formed in the handle 11. The water supply passage 112 and the air discharge passage 114 may be separately provided, and may be disposed in such a way that outlet ports of the two passages are close enough that water flowing from the water supply passage 112 to outside space is micronized or atomized by a shearing force of the compressed air flowing from the air discharge passage 114 to the outside space.

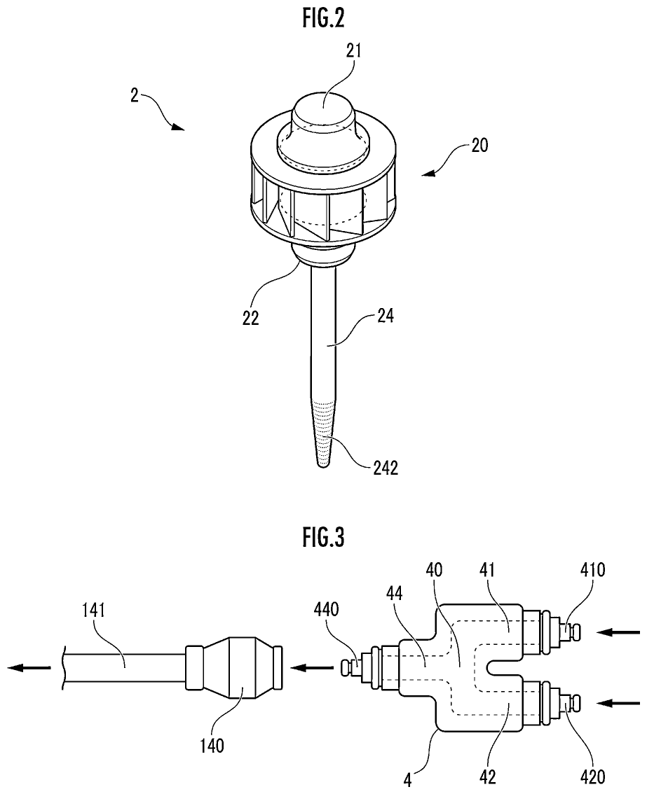

The air turbine 2 as an embodiment of the present invention shown in FIGS. 1 and 2 includes a rotary blade 20 (rotor), an upper shaft member 21 coaxially disposed on an upper side of the rotary blade 20, a lower shaft member 22 coaxially disposed on a lower side of the rotary blade 20, and a cutting tool 24 that has a tapered, substantially cylindrical shape and that extends coaxially downward from the lower shaft member 22. The housing 12 that sets the inner space 120 may be a structural element (shaft sealing device) of the air turbine 2.

The upper shaft member 21, the lower shaft member 22, and the cutting tool 24 may be integrally formed as one shaft member by metal with high hardness or ceramics. The cutting tool 24 may be removably fixed or coupled to the lower shaft member 22 by screwing or fitting, for example. The upper shaft member 21 and the lower shaft member 22 may be removably fixed or coupled to each other by screwing or fitting, for example, and removal and replacement of the rotary blade 20 may be performed by removing the upper shaft member 21 from the lower shaft member 22. An upper part of the housing 12 may be formed from a lid member that is sealed so as to enable replacement of the air turbine 2 or the rotary blade 20, and a user may be allowed to access the air turbine 2 when the lid member is opened or removed.

The rotary blade 20 is formed of ceramics or metal with a specific gravity of 3.0 or more or a combination thereof (including a composite material). As ceramics with a specific gravity of 3.0 or more, forsterite (2MgO·SiO₂) with a specific gravity of 3.0, silicon carbide (SiC) with a specific gravity of 3.16, silicon nitride (Si₃N₄) with a specific gravity of 3.3, aluminum nitride (AlN) with a specific gravity of 3.4, alumina (AL₂O₃) with a specific gravity of 3.8, yttria (Y₂O₃) with a specific gravity of 4.9, or zirconia (ZrO₂) with a specific gravity of 6.0 is used, for example. Cermet (TiC·TiN) that is a metal composite material and that has a specific gravity of 6.0 or a metal-ceramics composite material may also be used as a material of the rotary blade 20. As metal with a specific gravity of 3.0 or more, iron (specific gravity of 7.9), nickel (specific gravity of 8.8) or copper (specific gravity of 8.9) with a specific gravity of 4 or more, or an alloy thereof may be used, for example. The rotary blade 20 is formed into a desired shape through preparation of a powder molded body, burning of the powder molded body, and cutting of a sintered body. Desirably, the rotary blade 20 made with chromium or lead is wholly plated with harmless metal such as silver and/or nickel, for example. The specific gravity of the material of the rotary blade 20 is preferably 4.0 or more, more preferably 5.0 or more, and even more preferably 6.0 or more.

A ceramics-sprayed film (such as an yttria-sprayed film) may be formed on a surface of the rotary blade 20 that is made of metal such that the rotary blade 20 as a whole may achieve a specific gravity of 3.0 or more.

The rotary blade 20 of the air turbine 2 may be made of metal, and other structural elements may be made of ceramics. Lengths between a central axis line of the rotary blade 20 and distal parts of a plurality of blades that form the rotary blade 20 and that are arranged separately from one another in a circumferential direction may be such that a long length and a short length are alternately present in the circumferential direction. A blade for which the length between the central axis line of the rotary blade 20 and the distal part is long may be formed of a material with a higher or lower specific gravity than a blade for which the length between the central axis line of the rotary blade 20 and the distal part is short. At least one blade among the plurality of blades forming the rotary blade 20 may be formed to have a thickness that is increased continuously or in a stepwise manner from a proximal part near the central axis line of the rotary blade 20 to the distal part. A ceramics-sprayed film (such as an yttria-sprayed film) may be formed only on the distal part of a blade forming the rotary blade 20 made of metal such that a specific gravity of the distal part is locally increased compared to the proximal part of the blade.

### (Effects)

In the air turbine 2, the rotary blade 20 functions as a flywheel, and applies, to the cutting tool 24, a more powerful rotational driving force than in a conventional case by being caused to rotate at a high speed by compressed air that is supplied from the air supply passage 111 to the inner space 120 of the housing 12.

Even when the dental handpiece 1 is an already-existing product, the rotary blade 20 may be housed in the inner space 120 of the housing 12 of the already-existing dental handpiece. The rotary blade 20 itself functions as a flywheel, and thus, an additional flywheel does not have to be provided, and rotational torque of the rotary blade 20 may be increased. Accordingly, a rotational force of the cutting tool 24 that is coaxially coupled to the rotary blade 20 is also increased.

### Other Embodiments of Present Invention

As shown in FIG. 3, the dental handpiece 1 may include a boost adapter 4 including a three-path air passage 40. An outer shape of the boost adapter 4 does not have to match a shape of the air passage 40, and may adopt various shapes such as a substantially triangular plate shape, a substantially rectangular plate shape, a substantially trapezoidal plate shape, a substantially circular plate shapes, and a substantially elliptical plate shape. The air passage 40 includes a first air passage 41, a second air passage 42, and a combined air passage 44.

The first air passage 41 is coupled, via a first coupling part 410, to a first air supply pipe (not shown) connected to a first air supply circuit of the chair unit. For example, when the first coupling part 410 having a plug shape is fitted to a socket of the first air supply pipe (first air supply tube), a shut-off valve forming the socket is opened, and the first air supply circuit is thereby placed in communication with the first air passage 41 via the first air supply pipe. The second air passage 42 is coupled, via a second coupling part 420, to a second air supply pipe (not shown) connected to a second air supply circuit, of the chair unit, different from the first air supply circuit. For example, when the second coupling part 420 having a plug shape is fitted to a socket of the second air supply pipe (second air supply tube), a shut-off valve forming the socket is opened, and the second air supply circuit is thereby placed in communication with the second air passage 42 via the second air supply pipe. The combined air passage 44 is coupled, via a combination coupling part 440, to a coupling part 140 at a rear end portion of the air supply pipe 141. For example, when the combination coupling part 440 having a plug shape is fitted to the coupling part 140 having a socket shape, a shut-off valve forming the socket is opened, and the air supply pipe 141 is thereby placed in communication with the combined air passage 44.

When the boost adapter 4 is used, compressed air from two supply ports of the air supply circuits may be combined and supplied to the air turbine 2 of the dental handpiece 1. The air turbine 2 is thus rotated with high pressure that is nearly twice as much, and the rotational force of the cutting tool 24 is increased.

The boost adapter 4 can be applied as it is to a conventional dental handpiece. The air turbine is thus rotated with compressed air at a higher pressure than in a conventional case, and a rotational force of the cutting tool of a conventional dental handpiece may be increased.

### REFERENCE SIGNS LIST

1 dental handpiece
11 handle
110 inner space
111 air supply passage
112 water supply passage
114 air discharge passage
12 housing
120 inner space
122 ball bearing
124 opening
141 air supply pipe
142 water supply pipe
2 air turbine
20 rotary blade
21 upper shaft member
22 lower shaft member
24 cutting tool
242 filing part
4 boost adapter
40 three-path air passage
41 first air passage
410 first coupling part
42 second air passage
420 second coupling part
44 combined air passage
440 combination coupling part

1. An air turbine used in a dental handpiece, comprising:
a rotary blade, and a cutting tool which is coaxially coupled to the rotary blade, wherein
the rotary blade is formed from a blade made of metal and a ceramics-sprayed film formed on a surface of the blade to have a specific gravity of 3.0 or more.

2. A dental handpiece comprising:
a handle, a housing, and an air turbine, wherein
the air turbine includes a rotary blade, and a cutting tool which is coaxially coupled to the rotary blade, the rotary blade is formed of ceramics or metal with a specific gravity of 3.0 or more, or a combination of the ceramics and the metal, and the air turbine includes the rotary blade housed in an inner space of the housing, and the cutting tool which is coaxially coupled to the rotary blade, a tip end portion of the cutting tool protruding downward from the housing through an opening of the housing, and
the handle includes an air supply passage for supplying compressed air to the inner space of the housing, and an air discharge passage for discharging the compressed air from the inner space of the housing to below the housing and onto the cutting tool.

3. The dental handpiece according to claim 2, comprising:
a boost adapter including a three-path air passage formed from a first air passage and a second air passage which respectively communicate with a first air supply circuit and a second air supply circuit which are separate air circuits of a chair unit, and a combined air passage which combines the first air passage and the second air passage to communicate with the air supply passage.

4. (canceled)

5. The dental handpiece according to claim 2, wherein the rotary blade is formed from a blade made of metal and a ceramics-sprayed film formed on a surface of the blade to have a specific gravity of 3.0 or more.

6. The dental handpiece according to claim 5, wherein
the rotary blade has the ceramics-sprayed film formed on only a distal part of the blade such that a specific gravity of the distal part is locally increased compared to a proximal part of the blade.

7. The dental handpiece according to claim 2, wherein
the handle includes a water supply passage which is disposed in the inner space of the housing, the water supply passage being for supplying water to below the housing, and
the water which is supplied from the water supply passage to below the housing is micronized or atomized by a shearing force of the compressed air discharged from the air discharge passage to below the housing.
